(19) United States
(12) Patent Application Publication
(10) Pub. No.: US 2026/0331395 A1
(43) Pub. Date: Oct. 22, 2026

(54) KEY STRUCTURE

(71) Applicant: Primax Electronics Ltd., Taipei (TW)

(72) Inventors: Chun-Nan Su, Taipei (TW); Sheng-An Tsai, Taipei (TW); Zhen Chen, Taipei (TW)

(21) Appl. No.: 19/235,900

(22) Filed: Jun. 12, 2025

(30) Foreign Application Priority Data
Apr. 18, 2025 (CN) 202510491985.0

(51) Int. Cl. H01H 13/04; H01H 13/10; H01H 13/14; H01H 13/52

(52) U.S. Cl. CPC H01H 13/04; H01H 13/10; H01H 13/14; H01H 13/52

(57) ABSTRACT

A key structure is provided, which includes a key base, a keycap, an elastic member and one or a plurality of support portions. The key base defines an accommodating region. The keycap has a sleeve portion and an abutment portion extending downward from an inner top surface of the keycap, in which the sleeve portion surrounds the abutment portion, and the sleeve portion is configured to be engaged with the key base. The elastic member has a dome portion disposed in the accommodating region, in which the dome portion has a head portion. The one or the plurality of support portions are connected to the head portion of the dome portion and extend laterally outward, in which the abutment portion of the keycap is configured to abut against the one or the plurality of support portions.

### FIELD OF THE INVENTION

The present invention relates to a key structure.

### BACKGROUND OF THE INVENTION

Common input devices include mouse devices, keyboard devices, and trackball devices. Since the keyboard devices allow users to directly input text and symbols into computers, making them convenient to use and therefore is widely adopted.

A keyboard device generally includes a plurality of key structures, a membrane circuit board and a base plate. Each of the key structures typically includes a keycap, a scissor-type connecting element, and an elastic member. However, the key structure involves multiple components, resulting in increased assembly time and higher manufacturing cost.

### SUMMARY OF THE INVENTION

The present invention provides a key structure, which includes a key base, a keycap, an elastic member and one or a plurality of support portions. The key base defines an accommodating region. The keycap has a sleeve portion and an abutment portion extending downward from an inner top surface of the keycap, in which the sleeve portion surrounds the abutment portion, and the sleeve portion is configured to be engaged with the key base. The elastic member has a dome portion disposed in the accommodating region, in which the dome portion has a head portion. The one or the plurality of support portions are connected to the head portion of the dome portion and extend laterally outward, in which the abutment portion of the keycap is configured to abut against the one or the plurality of support portions.

In some embodiments of the present invention, the key structure includes the plurality of support portions, and the dome portion and the plurality of support portions are integrally formed.

In some embodiments of the present invention, the key structure includes four or more of the plurality of support portions.

In some embodiments of the present invention, the plurality of support portions are radially arranged when viewed from above.

In some embodiments of the present invention, an extension direction of one of the plurality of support portions is not parallel to any side edge of the keycap.

In some embodiments of the present invention, a vertical projection of the one or the plurality of support portions is located within a vertical projection of the dome portion.

In some embodiments of the present invention, the abutment portion has a column and a plurality of ribs, and the plurality of ribs are connected to the column and extend laterally outward.

In some embodiments of the present invention, a number of the plurality of ribs is greater than a number of the one or the plurality of supporting portions.

In some embodiments of the present invention, one of the plurality of ribs is connected to the sleeve portion.

In some embodiments of the present invention, the elastic member further has a connecting portion connected to a bottom edge of the dome portion, and the connecting portion has a pad portion corresponding to a portion of the sleeve portion, and a thickness of the pad portion of the connecting portion is greater than a thickness of a portion of the connecting portion other than the pad portion.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a perspective view of a key structure according to an embodiment of the present invention.

FIG. 2 is a three-dimensional exploded view of a key structure according to an embodiment of the present invention.

FIG. 3 is a top view of an elastic member and a supporting portion according to an embodiment of the present invention.

FIG. 4 is a bottom view of a keycap according to an embodiment of the present invention.

FIG. 5 is a cross-sectional view of a key structure according to an embodiment of the present invention.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, a keyboard device generally includes a plurality of key structures, a membrane circuit board and a base plate. Each of the key structures typically includes a keycap, a scissor-type connecting element, and an elastic member. However, the key structure involves multiple components, resulting in increased assembly time and higher manufacturing cost. The inventor has observed that, if the keyboard device adopts a whole-plate elastic member and each key structure does not include a scissor-type connection element, the assembly time and manufacturing cost can be significantly reduced. However, when a corner portion of the keycap of the above-mentioned key structure is pressed, the keycap tends to wobble, resulting in poor user comfort and an unsatisfactory pressing feel. Therefore, the present invention provides a key structure, which includes a key base, a keycap, an elastic member and one or a plurality of support portions, in which the one or the plurality of support portions are connected to the head portion of the dome portion of the elastic member and extend laterally outward to increase a support area of the keycap. In this way, when the corner portion of the keycap is pressed, the keycap is less prone to wobbling during downward movement, thereby improving user comfort and the pressing feel. Various embodiments of the key structure of the present invention will be described in detail below.

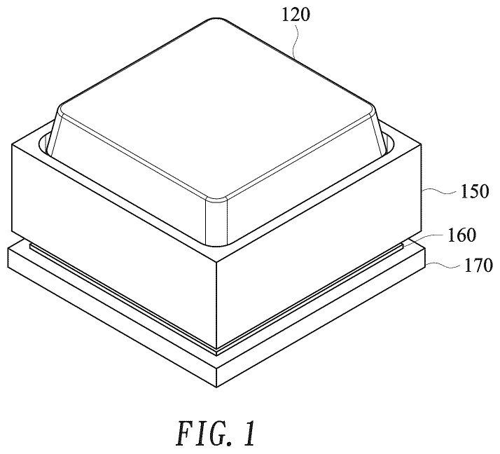

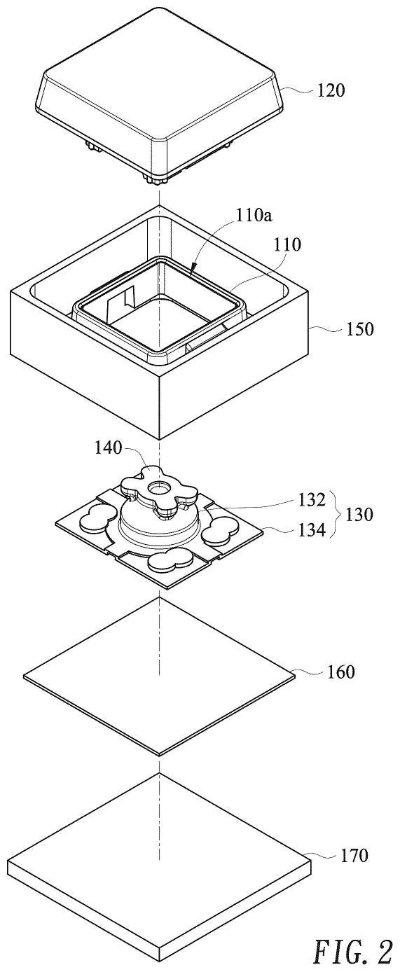

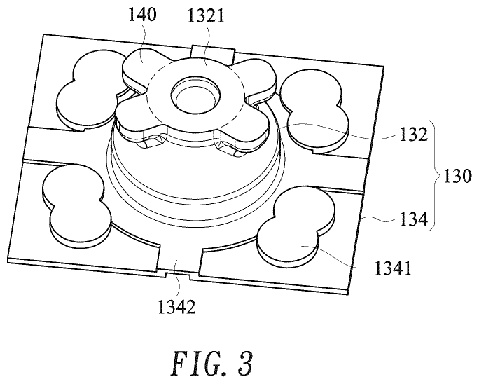

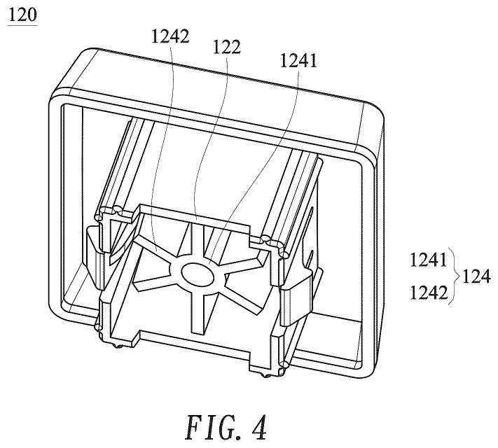

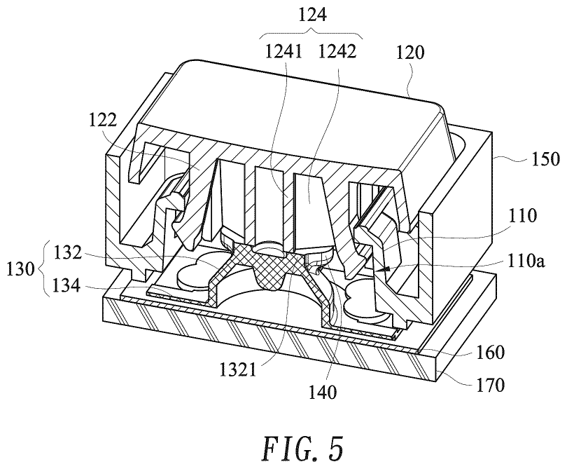

FIG. 1 is a perspective view of a key structure according to an embodiment of the present invention. FIG. 2 is a three-dimensional exploded view of a key structure according to an embodiment of the present invention. FIG. 3 is a top view of an elastic member and a supporting portion according to an embodiment of the present invention. FIG. 4 is a bottom view of a keycap according to an embodiment of the present invention. FIG. 5 is a cross-sectional view of a key structure according to an embodiment of the present invention. As shown in FIGS. 1 to 5, the key structure includes a key base 110, a keycap 120, an elastic member 130 and one or a plurality of support portions 140.

As shown in FIGS. 2 and 5, the key base 110 defines an accommodating region 110a. In some embodiments, the accommodating region 110a is configured to accommodate a sleeve portion 122 and an abutment portion 124 of the keycap 120, a dome portion 132 of the elastic member 130, and the one or the plurality of support portions 140. In some embodiments, as shown in FIG. 2, the key base 110 is a hollow square column structure, and a hollow region thereof is the accommodating region 110a. However, the present invention is not limited to the aforementioned embodiments, and the key base 110 may also be in other shapes.

In some embodiments, as shown in FIGS. 1, 2 and 5, the key structure further includes a key frame 150 that surrounds the key base 110. In some embodiments, the bottom of the key frame 150 is connected to the bottom of the key base 110. In some embodiments, the key base 110 and the key frame 150 are integrally formed.

As shown in FIGS. 4 and 5, the keycap 120 has the sleeve portion 122 and the abutment portion 124 extending downward from an inner top surface of the keycap 120. The sleeve portion 122 surrounds the abutment portion 124. As shown in FIGS. 2, 4 and 5, the sleeve portion 122 is configured to be placed in the accommodating region 110a and engaged with the key base 110.

In some embodiments, as shown in FIGS. 4 and 5, the abutment portion 124 has a column 1241 and a plurality of ribs 1242, in which the plurality of ribs 1242 are connected to the column 1241 and extends laterally outward. In some embodiments, the column 1241 is a hollow column, such as a hollow cylinder. However, the present invention is not limited to the aforementioned embodiments. In other embodiments, the abutment portion may be in other shapes as long as it can abut against the one or the plurality of support portions 140.

In some embodiments, as shown in FIG. 4, one of the plurality of ribs 1242 is connected to the sleeve portion 122. In some embodiments, as shown in FIGS. 3 and 4, a number of the plurality of ribs 1242 is greater than a number of the one or the plurality of support portions 140. However, the present invention is not limited to the aforementioned embodiments. In other embodiments, the number of the ribs may be the same as the number of the supporting portions.

As shown in FIGS. 2, 3 and 5, the elastic member 130 has the dome portion 132 disposed within the accommodating region 110a. The dome portion 132 has a head portion 1321. In some embodiments, as shown in FIGS. 3 and 5, the dome portion 132 further has a bracket portion (not labeled) and a contact portion (not labeled), and the bracket portion is connected to an edge of the head portion 1321, and the contact portion extends downward from a bottom surface of the head portion 1321.

As shown in FIGS. 2, 3 and 5, the one or the plurality of support portions 140 are connected to the head portion 1321 of the dome portion 132 and extend laterally outward. The abutment portion 124 of the keycap 120 is configured to abut against the one or the plurality of support portions 140. In some embodiments, the abutment portion 124 of the keycap 120 is also configured to abut against the head portion 1321 of the dome portion 132. In some embodiments, a vertical projection of the one or the plurality of support portions 140 is located within a vertical projection of the dome portion 132.

In some embodiments, as shown in FIG. 3, the key structure includes the plurality of support portions 140, and the elastic member 130 and the plurality of support portions 140 are integrally formed. In some embodiments, the key structure includes four or more of the support portions 140. In some embodiments, the plurality of support portions 140 are radially arranged when viewed from above. In some embodiments, as shown in FIGS. 2 to 4, an extension direction of one of the plurality of support portions 140 is not parallel to any side edge of the keycap 120. In this way, when a corner portion of the keycap 120 is pressed, the stability of the keycap 120 during downward movement can be improved.

However, the present invention is not limited to the above-mentioned embodiments. In other embodiments, the one or the plurality of supporting portions are not integrally formed with the elastic member. In some embodiments, the one or the plurality of supporting portions (not shown) are made of other materials (e.g., PET, Mylar), which cover the head portion 1321 of the dome portion 132 to increase the supporting area of the keycap 120.

In some embodiments, as shown in FIGS. 3 and 4, the elastic member 130 further has a connecting portion 134 connected to a bottom edge of the dome portion 132, and the connecting portion 134 has a pad portion 1341 corresponding to a portion of the sleeve portion 122, and a thickness of the pad portion 1341 of the connecting portion 134 is greater than a thickness of a portion of the connecting portion 134 other than the pad portion 1341. In these embodiments, since the pad portion 1341 is relatively thick, it functions to reduce noise generated when the keycap 120 is pressed to the bottom. In some embodiments, the connecting portion 134 has a plurality of pad portions 1341, which respectively correspond to a plurality of portions of the sleeve portion 122 (e.g., corner portions of the sleeve portion 122). In some embodiments, the connecting portion 134 further includes a vent portion 1342 that is directly connected to the bottom edge of the dome portion 132.

In some embodiments, as shown in FIGS. 2 and 5, the key structure further includes a membrane circuit board 160 and a base plate 170 disposed beneath the key base 110 and the elastic member 130.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. A key structure, comprising:
a key base, defining an accommodating region;
a keycap, having a sleeve portion and an abutment portion extending downward from an inner top surface of the keycap, wherein the sleeve portion surrounds the abutment portion, and the sleeve portion is configured to be engaged with the key base;
an elastic member, having a dome portion disposed in the accommodating region, wherein the dome portion has a head portion; and
one or a plurality of support portions, connected to the head portion of the dome portion and extending laterally outward, wherein the abutment portion of the keycap is configured to abut against the one or the plurality of support portions.

2. The key structure of claim 1, wherein the key structure comprises the plurality of support portions, and the dome portion and the plurality of support portions are integrally formed.

3. The key structure of claim 2, wherein the key structure comprises four or more of the plurality of support portions.

4. The key structure of claim 2, wherein the plurality of support portions are radially arranged when viewed from above.

5. The key structure of claim 2, wherein an extension direction of one of the plurality of support portions is not parallel to any side edge of the keycap.

6. The key structure of claim 1, wherein a vertical projection of the one or the plurality of support portions is located within a vertical projection of the dome portion.

7. The key structure of claim 1, wherein the abutment portion has a column and a plurality of ribs, and the plurality of ribs are connected to the column and extend laterally outward.

8. The key structure of claim 7, wherein a number of the plurality of ribs is greater than a number of the one or the plurality of supporting portions.

9. The key structure of claim 7, wherein one of the plurality of ribs is connected to the sleeve portion.

10. The key structure of claim 1, wherein the elastic member further has a connecting portion connected to a bottom edge of the dome portion, and the connecting portion has a pad portion corresponding to a portion of the sleeve portion, and a thickness of the pad portion of the connecting portion is greater than a thickness of a portion of the connecting portion other than the pad portion.
